(19) United States
(12) Patent Application Publication
(10) Pub. No.: US 2016/0066124 A1
(43) Pub. Date: Mar. 3, 2016

(54) ALERT MANAGER

(71) Applicant: APPLE INC., Cupertino, CA (US)

(72) Inventors: Chun-Ting Chang, San Jose, CA (US); Austen J. Green, Santa Clara, CA (US); Jonathan R. Dascola, San Francisco, CA (US); Christopher P. Foss, Cupertino, CA (US); Imran A. Chaudhri, San Francisco, CA (US); Gary I. Butcher, San Jose, CA (US); Stephen O. Lemay, Palo Alto, CA (US); Christopher I. Wilson, Cupertino, CA (US); Alan C. Dye, Cupertino, CA (US); Curtis Rothert, Cupertino, CA (US)

(21) Appl. No.: 14/475,445

(22) Filed: Sep. 2, 2014

(51) Int. Cl. H04W 4/00; H04W 4/12; H04B 1/3827

(52) U.S. Cl. CPC H04W 4/008; H04B 1/385; H04W 4/12

(57) ABSTRACT

Systems, methods, and computer-readable medium are provided for managing alerts of one or more computing devices. For example, a user device may configure a user interface to present electronic content corresponding to a first category. The user device may also receive a data structure of rules. At least one rule may correspond to an entry of the data structure for an alert category pairing. The user device may receive information that identifies and incoming alert and determine a presentation method for the incoming alert based at least in part on a corresponding rule. The user device may also present the incoming based at least in part on the determined presentation method.

### BACKGROUND

Wearable devices and other peripheral user electronics are becoming more and more popular. Such devices may connect via proximity-based network connections to other user devices, for example a headset connecting to a smartphone via a Bluetooth connection. Additionally, these peripheral devices are typically smaller and more portable than traditional consumer electronics. As such, they often include relatively smaller screens and/or have relatively shorter battery life. Often, a connected peripheral device may receive alerts from a source device or other computing system. The alerts may provide indications to a user about electronic content associated with the source and/or information requested by the peripheral. However, with a smaller screen size and/or shorter battery life, it can be difficult to manage the incoming alerts.

### BRIEF SUMMARY

Embodiments of the present disclosure can provide systems, methods, and computer-readable medium for managing alerts of one or more source devices. One or more source devices may be configured to establish and/or maintain a network connection with a peripheral user device (e.g., a wearable computing device or the like). Once established, the one or more source devices may provide electronic content and/or alerts to the peripheral device as desired. A table, matrix, or other data structure may be managed that includes alert presentation rules for instructing the peripheral device regarding how to present incoming alerts in light of currently presented alerts. For example, if first electronic content is being presented by the peripheral device, the matrix may be referenced to identify a presentation method for presenting an incoming alert. That presentation method may be different based at least in part on what is currently being presented on the peripheral and what alert is incoming. The presentation method may also be different based at least in part on a type of each alert.

According to one embodiment, a method may be executed by a wearable device to receive a first alert for presentation by a display device of the wearable computing device. The first alert may correspond to a first alert category of a plurality of alert categories. The wearable device may also be configured to present the first alert via the display device. In some examples, the wearable device may store a matrix of alert rules. The alerts rules may be configured for managing presentation of additional alerts corresponding to the plurality of alerts. The wearable device may also receive a second alert configured to be presented by the display device. In some cases, the second alert may correspond to a second alert category of the plurality of alert categories. The wearable device may determine a presentation procedure for the received second alert during presentation of the first alert. In some aspects, the determined presentation procedure may be based at least in part on a particular alert rule of the alert rules that corresponds to the first alert category and the second alert category. Further, the wearable device may present the second alert via the display device of the wearable computing device based at least in part on the determined presentation procedure.

In some aspects, the matrix of alert rules may comprise a row and a column for each of the plurality of alert categories. Additionally, each cell of the matrix may indicate a respective alert rule corresponding to a respective pair of individual alert categories of the plurality of alert categories. Additionally, each cell of the matrix may include metadata identifying additional instructions for the respective alert rule. In some aspects, the additional instructions may be configured to alter the presentation procedure. Further, in some examples, the determined presentation procedure may comprise at least one of overlaying the second alert with respect to the first alert, queuing the second alert, discarding the second alert, or displacing the first alert with the second alert. At least one of the first alert or the second alert may be received from a second computing device of the user.

According to another embodiment, a system may be implemented as a wearable computing device that includes memory configured to store computer-executable instructions and a processor in communication with the memory and the display device, where the processor is configured to execute the computer-executable instructions. The system may be configured to configure a user interface to present electronic content. In some cases, the electronic content may correspond to a first alert category of a plurality of alert categories. The system may also be configured to receive a data structure comprising a plurality of rules. In some cases, at least one rule of the plurality of rules may correspond to an entry of the data structure for an alert category pairing of the plurality of alert categories. The system may also be configured to receive information that identifies an incoming alert and/or determine a presentation method for the incoming alert based at least in part a corresponding rule of the plurality of rules. The system may also be configured to present the incoming alert based at least in part on determined presentation method.

In some aspects, the entry for the alert category pairing may comprise an intersection position in the data structure where a row and a column meet. Additionally, the alert category pairing may comprise a pair of respective alert categories of the plurality of alert categories. In some cases, the at least one rule may be configured to instruct the processor regarding presentation of the incoming alert during presentation of the electronic content. The system may be configured as a wearable device, the electronic content may be configured for presentation to a user of the wearable device, and the electronic content may be received from another computing device of the user. The electronic content or the incoming alert may comprise at least one of an audio alert, a visual alert, or a haptic alert. In some examples, at least one of the electronic content or the incoming alert may be received from a server external to the system. The data structure may be received from a developer computer, and the data structure may be configured to enable a developer associated with the developer computer to generate at least a subset of the plurality of rules. Additionally, in some cases, the incoming alert may correspond to a second alert category of the plurality of alert categories and the presentation method may be further determined based at least in part on the second alert category.

According to another embodiment, a computer-readable medium may include instructions that, when executed, configure a computer processor to provide a first alert to a user device for presentation by the user device. In some examples, the first alert may be associated with a first alert category. In some cases, the instructions may configure the computer processor to receive a data structure configured to store an alert rule for an alert category pair comprising the first alert category and a second alert category. The instructions may also configure the computer processor to identify a second alert configured to be presented by the user device. In some cases, the second alert may be associated with the second alert category. In some instances, the instructions may further configure the computer processor to determine a presentation instruction based at least in part on the alert rule for the alert category pair. The instructions may also configure the computer processor to provide the second alert and the presentation instructions to the user device. Further, in some examples, the instructions may also configure the computer processor to provide the data structure to a third-party computing device for including the alert rule and other alert rules for other alert category pairs.

In some examples, the presentation instruction may comprise information for presenting the second alert at a time when the first alert is being presented by the user device. The user device may be configured to present the second alert at the time when the first alert is being presented. Additionally, in some examples, the second alert and the presentation instruction may be provided to the user device during presentation of the first alert. Further, in some cases, the data structure may be received from the third-party computing device or another computing device external to the user device.

### BRIEF DESCRIPTION OF THE DRAWINGS

FIG. 1 is a simplified flow diagram illustrating at least some example techniques for managing alerts of one or more computing devices as described herein, according to at least one example.

FIG. 2 is another simplified flow diagram illustrating at least some additional example techniques for managing alerts of one or more computing devices as described herein, according to at least one example.

FIG. 3 is a simplified block diagram illustrating an example data structure for use managing alerts of one or more computing devices as described herein, according to at least one example.

FIG. 4 is a simplified block diagram illustrating an example architecture for implementing the management of alerts of one or more computing devices as described herein, according to at least one example.

FIG. 5 is a simplified flow diagram illustrating an example process for managing alerts of one or more computing devices as described herein, according to at least one example.

FIG. 6 is another simplified flow diagram illustrating an example process for managing alerts of one or more computing devices as described herein, according to at least one example.

FIG. 7 is another simplified flow diagram illustrating an example process for managing alerts of one or more computing devices as described herein, according to at least one example.

FIG. 8 is a simplified block diagram illustrating example devices for managing alerts of one or more computing devices as described herein, according to at least one example.

FIG. 9 is a simplified block diagram illustrating another example architecture for managing alerts of one or more computing devices as described herein, according to at least one example.

FIG. 10 is a simplified block diagram illustrating additional example devices for managing alerts of one or more computing devices as described herein, according to at least one example.

### DETAILED DESCRIPTION

In the following description, various examples will be described. For purposes of explanation, specific configurations and details are set forth in order to provide a thorough understanding of the examples. However, it will also be apparent to one skilled in the art that the examples may be practiced without the specific details. Furthermore, well-known features may be omitted or simplified in order not to obscure the example being described.

Examples of the present disclosure are directed to, among other things, managing alerts between electronic devices. In particular, a pair of user devices (or more than two) may communicate with one another via a wireless network connection or the like and, in some examples, one device may provide alerts to the other. Depending on the type of an alert being presented on a receiving device, one or more rules may be followed for presenting incoming alerts on that receiving device. For example, a first alert (e.g., an indication of an incoming telephone call) may be provided from a mobile telephone to a receiving device of a user (e.g., a mobile and/or wearable device). The receiving device may present the first alert on a screen to the user. While the first alert is being presented on the receiving device, the mobile phone may provide a second alert (e.g., an indication of an alarm) to the receiving device. One or more rules may be provided that may be configured to instruct the receiving device regarding how to handle the incoming alert while the first alert is being presented. Additionally, the rules may be for arbitrary numbers of stacked alerts, not just second and/or incoming alert.

In some examples, the incoming alert may be ignored, the incoming alert may be queued for later, the incoming alert may displace the first alert (e.g., the incoming alert may be presented and the first alert may be dismissed), and/or the incoming alert may be overlaid on top of the first alert (e.g., the incoming alert may be presented over the first alert with the first alert remaining active). In some cases, when the incoming alert is overlaid on top of the first alert, the first alert may be presented again after the incoming alert is dismissed. Additionally, when the incoming alert displaces the first alert, the first alert may be deactivated and/or the content or application associated with the alert may be terminated. Further, in some cases, the rules that instruct the receiving device of the presentation method or procedure for handling the incoming alert may be stored or otherwise managed by a data structure (e.g., a matrix or other data base structure) of the receiving device and/or the mobile phone.

In one example, a user may utilize a smartphone (e.g., a mobile phone with computer processing, network connectivity, and one or more software applications) and a smart watch (e.g., an electronic wrist watch or the like with computer processing, network connectivity, and/or one or more software applications). The smartphone and the smart watch may be connected via one or more network connections (e.g., Bluetooth, WiFi, or the like) and may be configured to communicate with one another. In some examples, as similarly described above, the smartphone may be configured to provide alerts to the smart watch. Alerts may include notifications (e.g., indications of information from one or more software applications and/or an operating system), alarm information, application information, battery information, system information, etc. In some examples, a data structure (e.g., a matrix) of alert rules may be stored on the smart watch and/or the smartphone. The matrix of alert rules may include instructions and/or metadata associated with how and/or when to present incoming alerts on the smart watch in light of alerts currently presented on the smart watch.

For example, the smart watch may be currently presenting electronic content of a software application (e.g., running on the smartphone and/or the smart watch). The electronic content may be considered an alert in that it may be included as a row or column of the matrix. The smartphone may receive information that identifies a new alert to be provided to the smart watch. For example, an incoming call or a system alert (e.g., video play failure or the like) may be identified and provided to the smart watch. The smart watch may reference the matrix of rules to determine what to do regarding the two alerts. In some examples, the matrix may include a row for applications and a column for system alerts. At a location in the matrix where the application row and the system alert column meet, a cell may include a rule and/or metadata corresponding to this particular alert pair scenario (that is, the scenario of application content being currently presented with an incoming system alert). The rule for this cell may indicate, by way of example only, that when application content is being presented and a system alert is incoming, that the system alert should be overlaid on top of the application content. This may include presenting the system alert in such a way that the system alert is visible, but that the application content is still active. While the system alert may be translucent such that the application content is still somewhat visible (e.g., from behind the system alert, virtually), the system alert may be presented in the forefront of the user interface. In this example (e.g., overlay), the application content may once again be presented in the forefront once the system alert is dismissed.

As noted, the matrix may be stored on either the receiving device (e.g., the smart watch in the above example) or the initiating device (e.g., the smartphone in the above example). When the matrix is stored and/or managed by the initiating device, however, the flow of events may be slightly different. For example, when the smartphone identifies the incoming alert to provide to the smart watch, the smartphone may first access the matrix to identify the appropriate rule. In this example, it may be that the smartphone receives information identifying the content/alert currently presented on the smart watch so that it knows which cell to reference in the matrix. However, in other examples, the smartphone may know the content being presented by the smart watch because it is the last content that the smartphone provided to the smart watch. In any case, the smartphone may reference the matrix to identify the appropriate alert presentation rule and may then provide the incoming alert to the smart watch with the appropriate rule. In this way, the smart watch may be able to function with less processing and/or data storage requests, thus enhancing or otherwise prolonging its battery life.

While examples are given where the receiving device is a smart watch and/or the initiating device is a smartphone, any consumer electronic devices may be configured to operate the alert manager and/or other features described herein. For example, the receiving device may be a headset, a portable audio or video device, or the like. Additionally, as noted above, the data structure may be a matrix; however, it may also be configured as any type of lookup table, database, or other system configured to enable the initiating device and/or the receiving device to access the appropriate alert rules. Further, while the data structure is described as being stored on the initiating device and/or the receiving device, it is understood that any computing system may be used to store and/or manage the data structure. For example, a remote service provider, external server, local area network device, or the like may be configured to receive requests from either of the initiating device or the receiving device and provide the appropriate rule (e.g., based at least in part on an application programming interface (API) method call or the like).

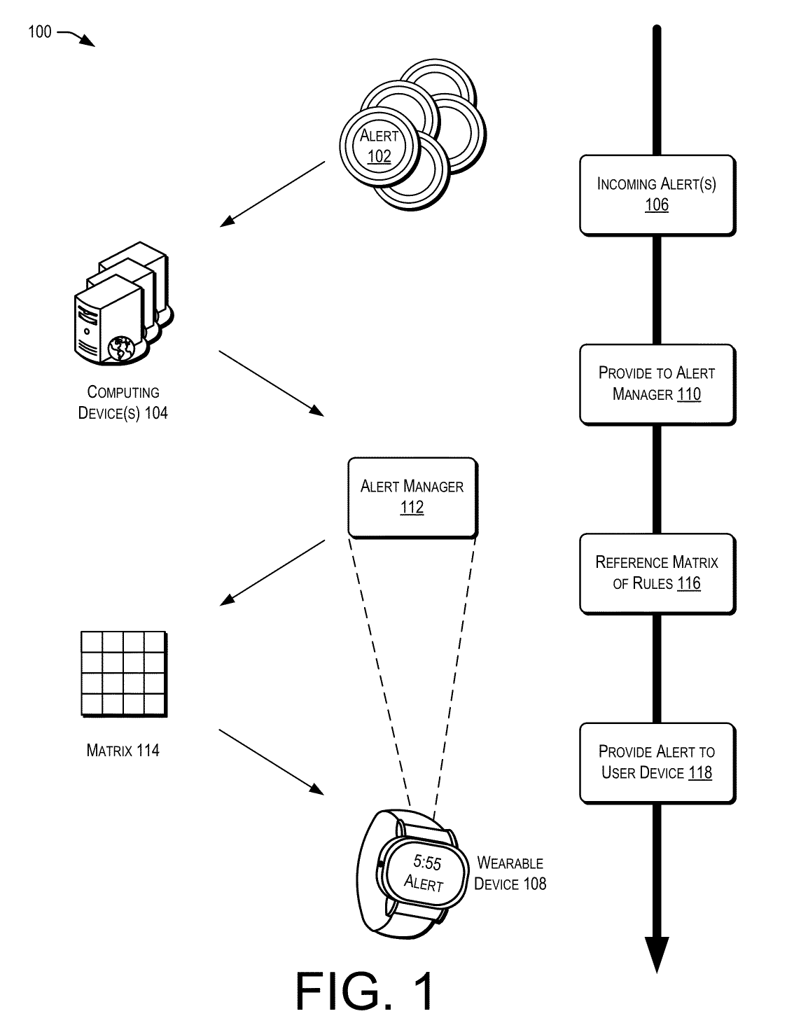

FIG. 1 illustrates a simplified flow diagram 100 depicting the management of alerts between computing devices, as described herein. In some examples, one or more incoming alerts 102 may be received or otherwise identified by one or more computing devices 104 (e.g., service provider computers and/or user devices) at 106. In some examples, the alerts 102 may include electronic content or may be identifiers of electronic content (e.g., a voice or video message or, alternatively, an indication of the message). Upon receipt of the alerts 102, the computing devices 104 may determine a particular second computing device for presentation of the alerts 102. For example, the computing device 104 may determine that one of the alerts 102 is intended, expected, or otherwise requested to be provided to a smart watch 108 or other wearable device. At 110, the computing device 104 may provide at least one of the alerts 102 to an alert manager 112. The alert manager may be a software module or other system configured to be stored on and/or executed by the computing device 104 and/or the smart watch 108. In some cases, the alert manager 112 may manage multiple different incoming alerts from several different computing devices 104.

In some aspects, the alert manager 112 may be configured with a data structure (e.g., a matrix or the like) 114 that includes one or more alert rules and/or metadata for supplementing the alert rules. At 116, the alert manager 112 may reference the matrix of rules 114 to determine or otherwise identify an appropriate rule for a particular combination or pair of alerts. As will be described in more detail below, an alert pair or an alert category pair may be identified within the matrix. The alert pair or alert category pair may describe a cell in the matrix 114 that corresponds to a first alert or first alert category row and a second alert or second alert category column. An alert category may comprise a set of alerts that can all be categorized as a single alert with regard to the matrix 114. For example, all system alerts (application malfunction indications, volume indications, power off indications, etc.) may be covered by a single alert category. At 118, the incoming alert 102 may be provided to the smart watch 108 based at least in part on the appropriate rule that was identified in the matrix 114. As noted, the alert manager 112 may be configured to manage alerts from a plurality of computing devices 104. As such, different rows and/or columns may also apply to the same alert or alert category, but for a different source device, respectively. Additionally, a different matrix 114 for each source device may be used as desired.

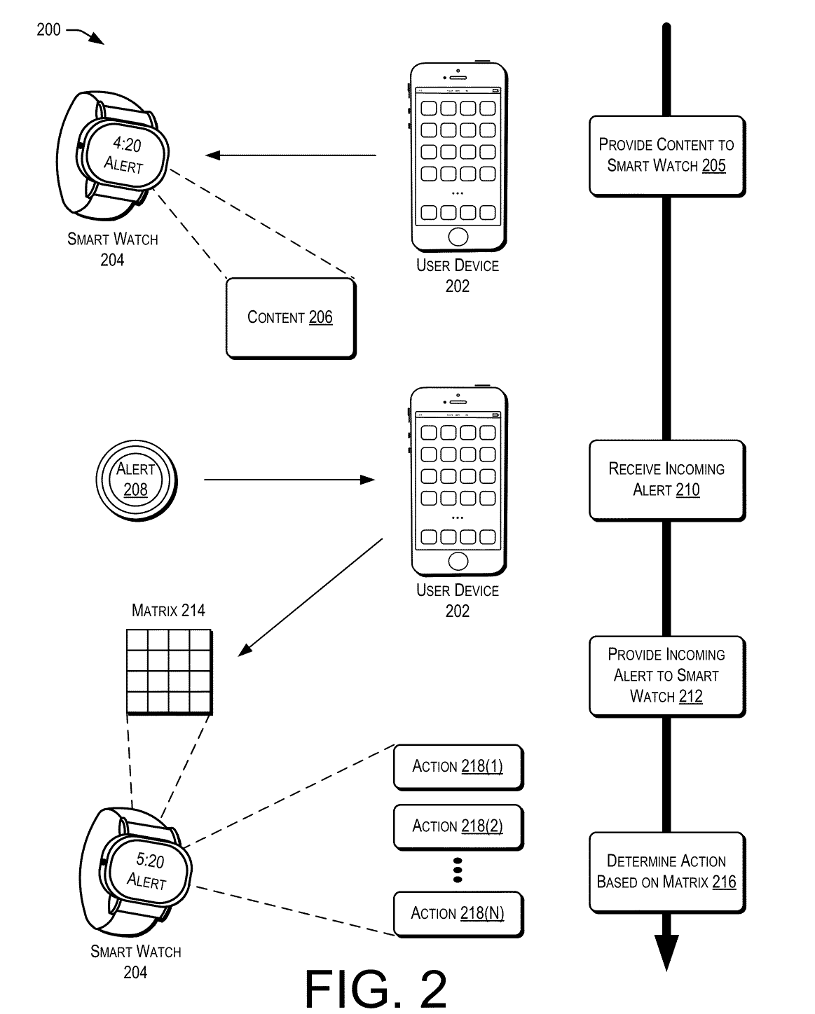

FIG. 2 illustrates a simplified flow diagram 200 depicting the management of alerts between computing devices, as described herein. In some examples, a first user device 202, such as a mobile phone or the like, may be in communication via one or more networks with a second user device 204, such as a smart watch or other wearable device. The first user device 202 may be configured to execute one or more software applications and/or provide electronic content via a user interface. In some examples, the electronic content may be hosted by a third-party server or the like and received at the first user device 202. At 205, the first user device 202 may be configured to provide content 206 to the smart watch 204. The content 206 may be an alert (e.g., an indication of electronic content, a notification, etc.) and/or the electronic content itself. The smart watch 204 may present the content 206 on a user interface of the smart watch 204. In some cases, due to physical space and/or battery life constraints, the smart watch 204 may include a smaller than normal screen with regard to most user devices. As such, there may only be room on the user interface of the smart watch 204 for the content 206 and/or one or more other user interface elements.

In some examples, the user device 202 may receive or identify an incoming alert 208 at 210. The incoming alert 208 may be provided by a server, service provider, external computing device, or the like. At 212, the user device 202 may provide the incoming alert 208 to the smart watch 204. Due to the potentially limited amount of user interface space on the smart watch 204, it may not be desired or possible to display the incoming alert 208 and the content 206 at the same time. As such, the smart watch 204 may reference a matrix 214 or other data structure for determining a presentation method or presentation rule corresponding to the particular scenario (e.g., the alert or alert category pair). At 216, the smart watch 204 may determine an action (e.g., the presentation method) associated with the incoming alert 208 based at least in part on the matrix 214. For example, the content 206 may be any one of the following types of content: A—an audio track being played, B—an indication of an incoming telephone call, or C—an image from a library. Additionally, the incoming alert may be any of the following types of content: D—an indication of a text message or E—an alarm. Thus, the actions 218(1)-(N) may each correspond to a different content-alert pairing. For example, the action 218(1) may correspond to the A-D pairing, which occurs when the electronic content 206 comprises an audio track being played by the smart watch 204 and the incoming alert 208 comprises an indication of a text message. The action that corresponds to this pair may be to overlay the incoming alert 208 on top of the application playing the audio track. When a user dismisses the incoming alert 208 (e.g., by swiping or otherwise indicating that the alert has been viewed), the incoming alert 208 may disappear and the audio application playing the track may reappear. The audio track may have continued to play through the overlay or it may have paused, as desired.

In some cases, the alert manager and/or matrix 214 may be configured to instruct the smart watch 204 to suppress all alerts during certain periods. For example, alerts may be suppressed during a setup stage of the smart watch 204. In this way, alerts will not interfere with the setup of the smart watch and/or software applications being installed thereon. Additionally, in some cases, the alerts may be suppressed during the execution of certain software application (e.g., certain games that enable users to draw on the screen, interact with other users, virtually pay for items or services, or the like). In some cases, these software applications that are configured to not be interrupted may be included as their own row and/or column of the matrix 214.

It should be understood by one of ordinary skill in the art, that FIGS. 1 and 2 are but two examples of many, and that variations of the types and number of computing devices may exist without departing from the general spirit of the disclosure. For example, the smart watch 108 or other user device of FIG. 1 may be able to reference the alert manager 112 and/or the matrix 114 without the use of any other computing devices. In this example, the alert 102 may be based at least in part on an application running solely on the smart watch 108. Additionally, future incoming alerts and/or other alerts may also be from local applications or the operating system of the smart watch 108 itself, as opposed to being received from the computing device 104 or any other devices. As such, the term “incoming” may merely refer to the fact that the alert 102 has not yet been presented on a user interface of the smart watch 108, and not that it was received from an external source. Similarly, with reference to FIG. 2, the smart watch 204 may be configured to execute an alert manager that references the matrix 214 for determining presentation methods or presentation procedures associated with local alerts (e.g., alerts that are not necessarily received from the user device 202 or any other device.

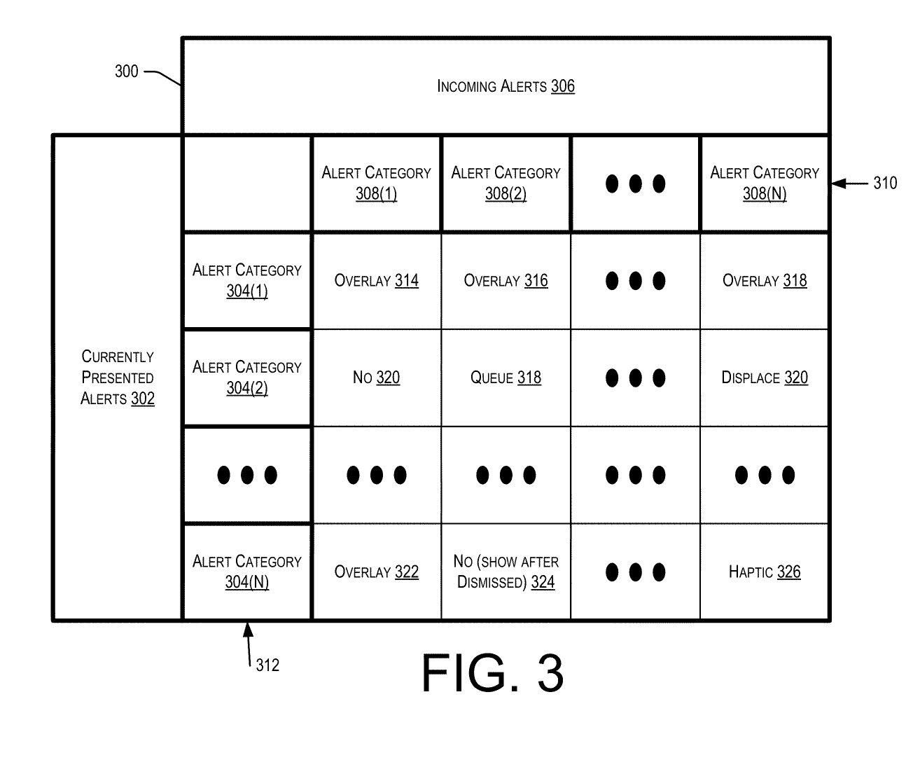

FIG. 3 illustrates a simplified block diagram depicting a matrix 300 configured to store or otherwise manage alert and/or alert category rules for managing alerts between computing devices, as described herein. In at least one example, the matrix 300 may include a set of rows that identify types or categories of currently presented alerts 302. For example, the currently presented alerts 302 may be alerts or electronic content currently being presented on a user interface or via one or more other output devices (e.g., a speaker, through a haptic device such as a vibrating or spinning object, etc.). For example, the currently presented alerts 302 may be alerts or alert categories such as, but not limited to, alert category 304(1) through alert category 304(N). Examples of alert categories 304(1)-(N) include, but are not limited to, alarm alerts, application alerts, battery alerts, special application alerts (e.g., applications that have special functionality different from regular applications), lock screen alerts, notification alerts (e.g., indications of particular events not covered under application alerts), power down or power up alerts, personal helper alerts (e.g., applications with particular functionality for helping the user), payment application alerts, system alerts, or timer alerts.

In some aspects, the matrix 300 may include a set of columns that also identify types of categories of incoming alerts 306. The incoming alerts 306 may also be alerts or electronic content requesting to be presented by a user interface of a user device. For example, the incoming alerts 306 may be alerts or electronic content configured to be presented on the user interface or via one or more other output devices (e.g., a speaker, through a haptic device such as a vibrating or spinning object, etc.) of the same device as that which is currently presenting the currently presented alerts 302. For example, the incoming alerts 302 may be alerts or alert categories such as, but not limited to, alert category 308(1) through alert category 308(N). Examples of alert categories 304(1)-(N) include the same set, a subset of, or a different set of alerts as those listed above with reference to alert categories 304(1)-(N).

In some examples, each cell of the matrix 300, other than those cells in row 310 and column 312, may reference a rule and/or some metadata for instructing the user device about the presentation method or procedure for presenting the incoming alerts 306 when the currently presented alerts 302 are being presented. As such, each cell may also correspond to an alert pair or pairing. For example, cell 314 labeled “overlay” corresponds to the pairing of alert category 304(1) and 308(1), cell 316 corresponds to the pairing of alert category 304(1) and 308(2), and cell 318 corresponds to the pairing of alert category 304(1) and some alert category after 308(2) (e.g., 308(N)). Similarly, cell 320 labeled “no” corresponds to the pairing of alert category 304(2) and 308(1), cell 322 labeled “queue” corresponds to alert category 304(2) and 308(2), and so on. Thus each alert category pairing may have a particular cell and/or rule for handling the scenario of one of the pairing being currently presented when the other of the pairing is incoming.

In some examples, the cell may indicate a priority in that the incoming alert may appear to trump the currently presented alert (e.g., because the incoming alert may displace or otherwise cover up the currently presented alert). However, no priority should be implied by the associated rules and/or metadata. For example, a first incoming alert “X” may displace a first presented alert “Y”; however, if the alerts were switched (e.g., “Y” was incoming while “X” was currently presented), “Y” may displace “X.” As noted above, a cell labeled “overlay” may indicate that the incoming alert is to be presented on top of the currently presented alert, and that the currently presented item will be restored when the incoming alert is dismissed. A cell labeled “displace” may indicate the incoming alert is to be presented and the currently presented alert is to be dismissed. A cell labeled “no” may indicate that the incoming alert is not to be presented when the currently presented alert is being presented (e.g., the incoming alert may be ignored or included on a list of notifications that were missed). A cell labeled “queue” may indicate that the incoming alert is to be placed into a queue and batched for a later time or is to be queued at least until the currently presented alert is dismissed or some other alert is presented that does not have a “no” or “queue” rule for the queued alert. A cell labeled “haptic” may indicate that a haptic response is to be presented to the user (e.g., the user device may buzz or vibrate without presenting anything visually). Additionally, “audio” may indicate that a sound is to be played either with or without the haptic feedback. Further, as noted, some cells may contain metadata. For example, cell 324 indicates “no (show after dismissed),” where “show after dismissed” is the metadata. Thus, cell 324 indicates that the incoming alert for this pairing should not be presented when for the currently presented alert; however, it should later be presented when the currently presented alert is dismissed.

While only a few rows, columns, and cells are shown in FIG. 3, any number of rows, columns, and cells may be envisioned and/or included in the matrix 300. Alert categories may include specific alerts and/or groupings of alerts with similar priority and/or characteristics. Additionally, a user or developer may be able to configure the cells with custom rules and/or metadata to customize the functionality of the alert manager. For example, an empty or partly empty matrix 300 may be provided to a developer and/or user interface team for configuring the alert manager prior to deploying the alert manager on the user device. However, in other examples, the matrix 300 may pre-filled or otherwise designed when deployed, and code may be downloaded to the user device to further configure or otherwise revise the alert rules of the matrix 300. Certain alerts rules may be configurable while others may be locked. Further, in some examples, each third-party application of the user device may be configured with its own matrix. In this way, the alert manager may reference one or more different matrices depending on the application that is currently in focus on the user device.

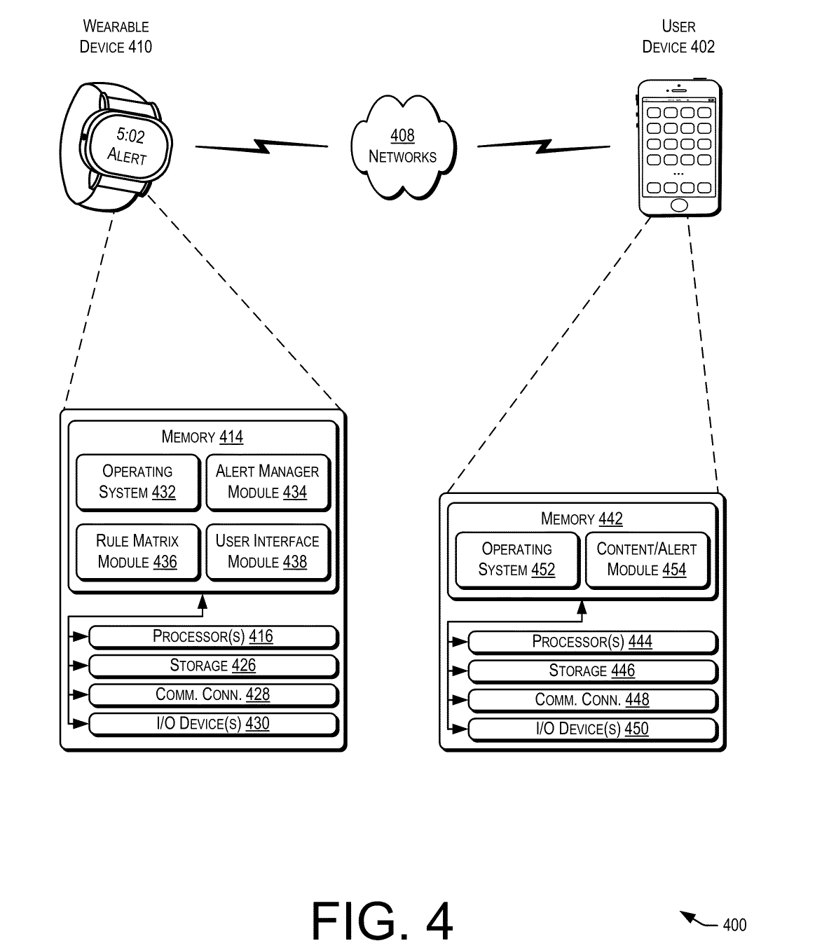

FIG. 4 illustrates an example architecture or environment 400 configured to implement the management of alerts between computing devices, according to at least one example. In some examples, the example architecture 400 may further be configured to manage or otherwise interact with one or more service provider computers or other computing devices of FIGS. 1 and/or 2. In some examples, the devices may be connected via one or more networks 408 (e.g., via Bluetooth, WiFi, the Internet, or the like). In the architecture 400, one or more users may utilize the user device 402 to manage, control, or otherwise utilize the wearable device 410, via the one or more networks 408.

In some examples, the networks 408 may include any one or a combination of many different types of networks, such as cable networks, the Internet, wireless networks, cellular networks, satellite networks, other private and/or public networks, or any combination thereof. While the illustrated example represents the user device 402 accessing the wearable device 410 via the networks 408, the described techniques may equally apply in instances where the user device 402 interacts with the wearable device 410 over a landline phone, via a kiosk, or in any other manner. It is also noted that the described techniques may apply in other client/server arrangements (e.g., set-top boxes, etc.), as well as in non-client/server arrangements (e.g., locally stored applications, peer to peer configurations, etc.).

As noted above, the user device 402 may be configured to execute or otherwise manage user applications (e.g., a web browser, third-party applications, a mapping applications, etc.). In some examples, user device 402 may be configured to collect health, fitness, activity, and/or medical data of the user. In turn, this data may be used by the user device 402 to present a user interface and/or provide information to the wearable device 410 for presenting a user interface. The user device 402 and/or the wearable device 410 may be any type of computing device such as, but not limited to, a mobile phone, a smartphone, a personal digital assistant (PDA), a laptop computer, a desktop computer, a thin-client device, a tablet computer, a smart watch, or the like. The wearable device may also be embodied as a necklace, clothing, glasses or the like. As noted, the user device 402 may be in communication with the wearable device 410 via the networks 408, or via other network connections.

In one illustrative configuration, the wearable device 410 may include at least one memory 414 and one or more processing units (or processor(s)) 416. The processor(s) 416 may be implemented as appropriate in hardware, computer-executable instructions, firmware, or combinations thereof. Computer-executable instruction or firmware implementations of the processor(s) 416 may include computer-executable or machine-executable instructions written in any suitable programming language to perform the various functions described. The wearable device 410 may also include geo-location devices (e.g., a global positioning system (GPS) device or the like) for providing and/or recording geographic location information associated with the wearable device 410.

The memory 414 may store program instructions that are loadable and executable on the processor(s) 416, as well as data generated during the execution of these programs. Depending on the configuration and type of the wearable device 410, the memory 414 may be volatile (such as random access memory (RAM)) and/or non-volatile (such as read-only memory (ROM), flash memory, etc.). The wearable device 410 may also include additional removable storage and/or non-removable storage 426 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 414 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 414 and the additional storage 426, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 414 and the additional storage 426 are both examples of non-transitory computer storage media. Additional types of computer storage media that may be present in the user device 102 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the wearable device 410. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The wearable device 410 may also contain communications connection(s) 428 that allow the wearable device 410 to communicate with a data store, another computing device or server, user terminals and/or other devices via the networks 408. The wearable device 410 may also include I/O device(s) 430, such as a keyboard, a mouse, a pen, a voice input device, a touch input device, a display, speakers, a printer, etc.

Turning to the contents of the memory 414 in more detail, the memory 414 may include an operating system 432 and/or one or more application programs or services for implementing the features disclosed herein including an alert manager module 434, a rule matrix module 436, and/or a user interface module 438. In some examples, the alert manager module 434 may be configured to manage and/or determine appropriate actions to take based at least in part on currently presented alerts and incoming alerts. For example, and as discussed above, a different action may be assigned to different alert pairings and/or alert category pairings. In this way, the alert manager module 434 can determine and/or identify a presentation method or procedure for an incoming alert even when the wearable device is currently presenting an alert and/or electronic content. As noted, electronic content may include alerts; however, it also may include the content that the alert is identifying. For example, a telephone call from the user device 402 may be electronic content to be presented via the wearable device. However, an indication of the incoming telephone call is the alert for that electronic content.

In some examples, the rule matrix module 436 may be configured to store and/or manage the alert rules stored in the matrix of alert rules. The alert matrix module 436 may be responsible for providing the matrix to third-parties for configuring, receiving the matrix once updated, and/or storing the matrix. Additionally, the rule matrix module 436 may be configured to communicate with the alert manager module 434 when a determination is requested for how to handle an incoming alert. The user interface module 438 may configured to managing the user interface of the wearable device 410. For example, once a rule is determined or identified for presenting an incoming alert, the user interface module 438 may be configured for presenting the incoming alert for either a “displace” or “overlay” action.

The user device 402 may also be any type of computing device. In one illustrative configuration, the user device 402 may include at least one memory 442 and one or more processing units (or processor(s)) 444. The processor(s) 444 may be implemented as appropriate in hardware, computer-executable instructions, firmware, or combinations thereof. Computer-executable instruction or firmware implementations of the processor(s) 444 may include computer-executable or machine-executable instructions written in any suitable programming language to perform the various functions described.

The memory 442 may store program instructions that are loadable and executable on the processor(s) 444, as well as data generated during the execution of these programs. Depending on the configuration and type of the user device 402, the memory 442 may be volatile (such as RAM) and/or non-volatile (such as ROM, flash memory, etc.). The user device 402 may also include additional removable storage and/or non-removable storage 446 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 442 may include multiple different types of memory, such as SRAM, DRAM, or ROM. While the volatile memory described herein may be referred to as RAM, any volatile memory that would not maintain data stored therein once unplugged from a host and/or power would be appropriate. The memory 442 and the additional storage 446, both removable and non-removable, are both additional examples of non-transitory computer-readable storage media.

The user device 402 may also contain communications connection(s) 448 that allow the user device 402 to communicate with a data store, another computing device or server, user terminals and/or other devices via the networks 408. The user device 402 may also include I/O device(s) 450, such as a keyboard, a mouse, a pen, a voice input device, a touch input device, a display, speakers, a printer, etc.

Turning to the contents of the memory 442 in more detail, the memory 442 may include an operating system 452 and/or one or more application programs or services for implementing the features disclosed herein including a content/alert module 454. In some examples, the content/alert module 454 may be configured to receive, determine, and/or provide electronic content and/or alerts to the wearable device 410 when appropriate. For example, in some examples, the user device 402 may be executing software applications that request to provide content or alerts to the wearable device 410. As such, the content/alert module 454 may be configured for this purpose. Additionally, in some examples, the content/alert module 454 may also be configured with its own alert manager and/or rule matrix. In this way, the user device 402 may manage the alerts, determine and/or identify the presentation methods for the incoming alerts, and provide the incoming alerts with instructions for presenting the incoming alert to the wearable device 410.

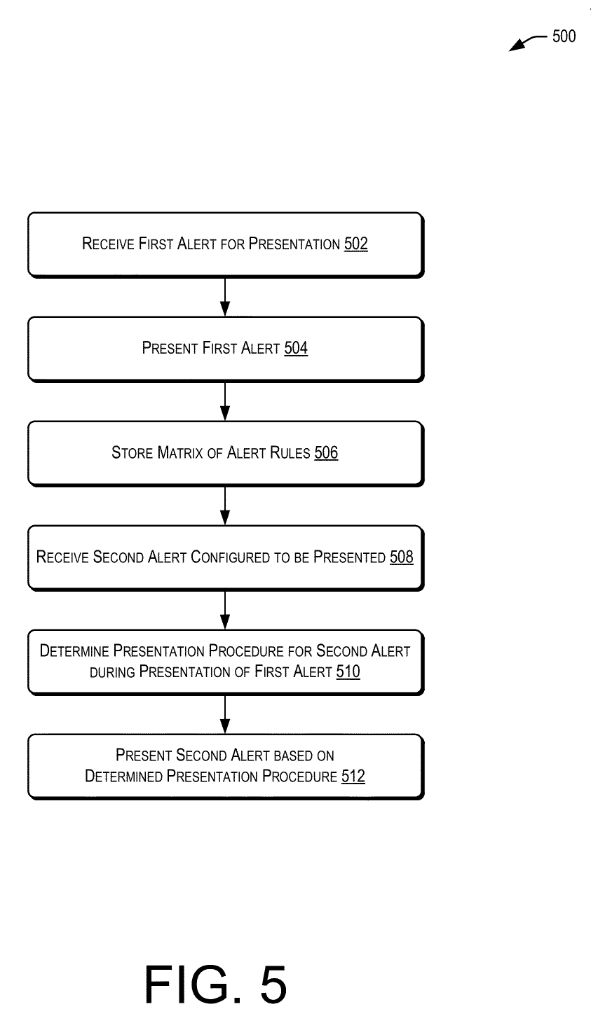

FIGS. 5-7 illustrate example flow diagrams showing processes 500, 600, and 700 for managing alerts of computing devices, according to at least a few embodiments. In some examples, the wearable device 410 of FIG. 4 (e.g., utilizing at least the alert manager module 434 shown in FIG. 4) may perform the process 500 of FIG. 5. The process 500 may begin at 502 where the wearable device 410 may receive a first alert for presentation. The first alert may be configured for presentation on a display device of the wearable device 410 and/or another user device. In some examples, the first alert may correspond to an alert category. At 504, the wearable device 410 may present the first alert via the display device. In some aspects, the wearable device 410 may store a matrix of alert rules at 506. Alternatively, the matrix of alert rules may be stored remotely. The alert rules may be configured for managing presentation of additional alerts corresponding to the alert category or a set of alert categories. At 508, the wearable device 410 may receive a second alert configured to be presented. The second alert may correspond to a different alert category, although it may correspond to the same alert category as the first alert.

In some examples, the wearable device 410 may be configured to determine a presentation procedure for the second alert during presentation of the first alert at 510. In other words, the wearable device 410 may be in the process of presenting the first alert when the second alert is received. Additionally, the presentation procedure may instruct the wearable device 410 regarding how to present the second alert during the presentation of the first alert. In some examples, the presentation procedure is based at least in part on a particular alert rule that corresponds to the first alert category and the second alert category. That is, the pairing of the first alert category and the second alert category may correspond to a cell of a matrix or the like. When the alert matrix is stored locally (e.g., on the wearable device 410), the alert manager module 434 may reference the locally stored alert matrix to determine the appropriate rule. Additionally, the wearable device 410 may have received the alert matrix from an owner and/or developer of the rules. However, in some cases, the matrix may be stored by the owner and/or developer of the rules (e.g., on a server or the like external to the wearable device 410). In this case, the alert manager module 434 may be configured to query the owner/developer of the matrix for the appropriate rule of the matrix. Further, in some examples, a default set of rules may be included in the matrix (e.g., when received and/or stored by the alert manager 434 of the wearable device 410) for instances when the owner/developer is unable to provide the appropriate rules of the matrix. At 512, the wearable device 410 may be configured to present the second alert via the display device based at least in part on the determined presentation procedure. In other words, the wearable device 410 may overlay, display, queue, or not present the second alert based at least in part on the type of second alert and the type of the first alert.

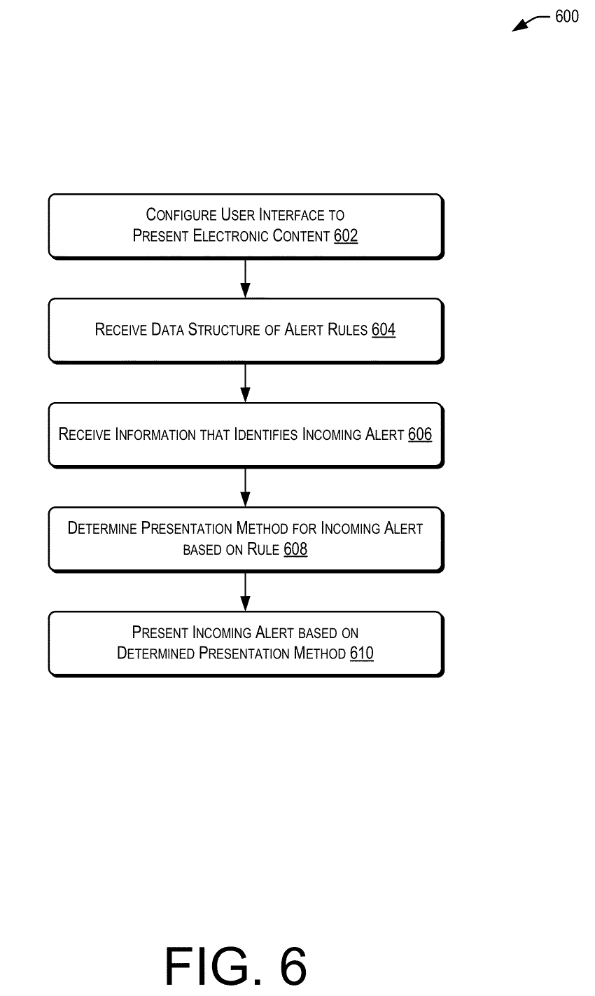

FIG. 6 illustrates another process 600 for managing alerts of computing devices, according to at least a few embodiments. In some examples, the wearable device 410 of FIG. 4 (e.g., utilizing at least the alert manager module 434 shown in FIG. 4) may perform the process 600 of FIG. 6. The process 600 may begin at 602 where the wearable device may configure a user interface to present electronic content. The electronic content may be received from another user device (e.g., a mobile phone or the like) or it may be prepared locally by a software application executed by the wearable device 410. Additionally, the electronic content may correspond to one of a set of alert categories. At 604, the wearable device 410 may be configured to receive a data structure comprising a plurality of rules. In some examples, the data structure may be configured as a matrix. Additionally, at least one of the plurality of rules may correspond to an entry of the data structure (e.g., a cell of the matrix or an entry of a database). In some examples, the wearable device 410 may also be configured to receive information identifying an incoming alert at 606. The incoming alert may identify additional content for the wearable device 410 to process and/or present.

In some examples, the wearable device 410 may be configured to determine a presentation method for presenting the incoming alert at 608. The determination may be made based at least in part on a corresponding rule of the plurality of rules (e.g., from the matrix). However, in other examples, the wearable device 410 may query an external or third-party computing system for the corresponding rule (e.g., stored in a matrix or data structure of the external or third-party computing system). Further, at 610, the wearable device 410 may present the incoming alert based at least in part on determined presentation method. For example, if the presentation method indicates that the incoming alert should be queued, the wearable device 410 will queue the incoming alert. Other presentation methods, as described above, may be utilized as desired and/or as prescribed by the data structure.

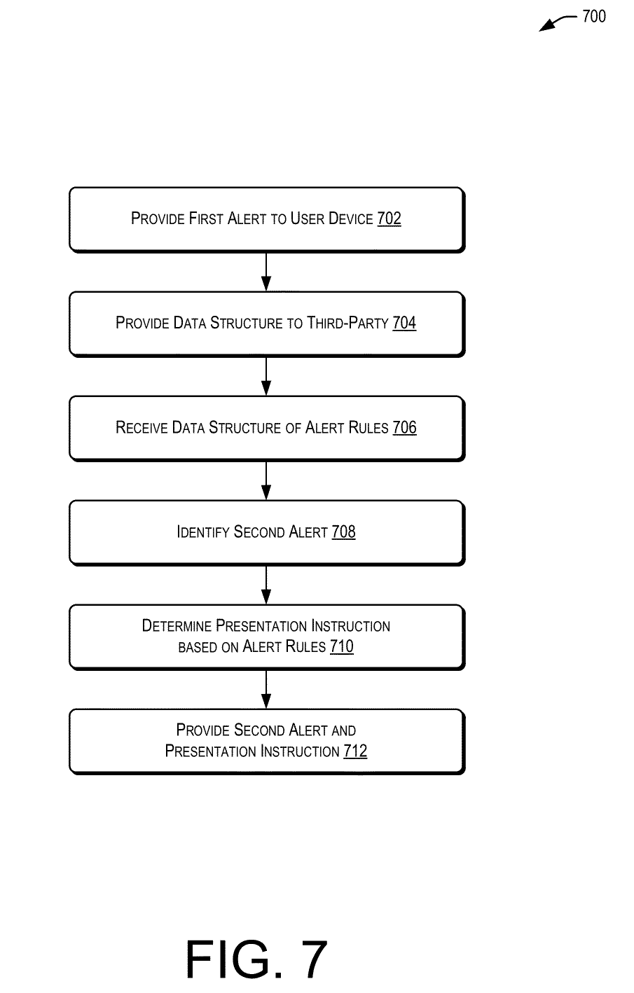

FIG. 7 illustrates another process 700 for managing alerts of computing devices, according to at least a few embodiments. In some examples, the user device 102 of FIG. 4 (e.g., utilizing at least the content/alert module 454 and/or an alert manager module similar to the alert module 434 but executed on the user device 402 shown in FIG. 4) may perform the process 700 of FIG. 7. The process 700 may begin at 702 where the user device 402 may provide a first alert to another user device (e.g., the wearable device 410 of FIG. 4). The first alert may be configured for presentation on the wearable device 410 and/or associated with a first alert category. In some examples, the user device 402 may be configured to provide a data structure to a third-party service or development system at 704. The data structure may be configured to store an alert rule for an alert category pair. The alert category pair may be made up of the first category (e.g., corresponding to the first alert) and a second category. At 706, the user device 402 may be configured to receive the data structure. The data structure may be received from the third-party service, the development system, and/or any other computing device.

In some examples, the user device 402 may be configured to identify a second alert configured to be presented by the wearable device 410 at 708. In some cases, the second alert may be associated with a second alert category. The first alert category and the second alert category may be the same. At 412, the user device 402 may be configured to determine a presentation instruction. The determination may be made based at least in part on the data structure of alert rules. Additionally, the presentation instruction may be configured to instruct the wearable device 410 regarding how and/or when to present the second alert (e.g., while the first alert is already being presented). At 712, the user device 402 may be configured to provide the second alert and the presentation instruction to the wearable device 410. In this way, the wearable device 410 may be able to present the second alert (e.g., the incoming alert) while the first alert is still being presented and based at least in part on the rule from the data structure.

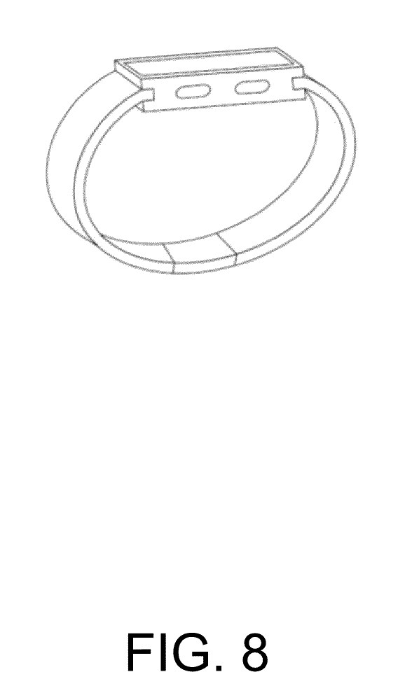

Embodiments described herein may take the form of, be incorporated in, or operate with a suitable electronic device. One example of such a device is shown in FIG. 8 and takes the form of a wearable mechanism. As shown, the mechanism may be worn on a user's wrist and secured thereto by a band. The mechanism may have a variety of functions including, but not limited to: keeping time; monitoring a user's physiological signals and providing health-related information based on those signals; communicating (in a wired or wireless fashion) with other electronic devices, which may be different types of devices having different functionalities; providing alerts to a user, which may include audio, haptic, visual and/or other sensory output, any or all of which may be synchronized with one another; visually depicting data on a display; gather data form one or more sensors that may be used to initiate, control, or modify operations of the device; determine a location of a touch on a surface of the device and/or an amount of force exerted on the device, and use either or both as input; accepting voice input to control one or more functions; accepting tactile input to control one or more functions; and so on.

Alternative embodiments of suitable electronic devices include a; a tablet computing device; a portable media player; and so on. Still other suitable electronic devices may include laptop/notebook computers, personal digital assistants, touch screens, input-sensitive pads or surfaces, and so on.

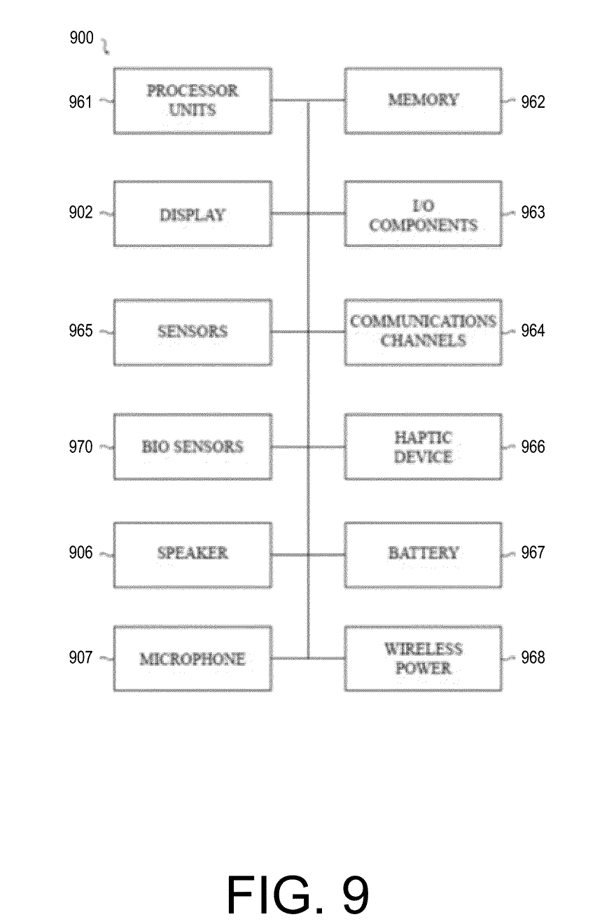

FIG. 9 depicts an example schematic diagram of a wearable electronic device. As shown in FIG. 9, the device 900 includes one or more processing units 961 that are configured to access a memory 962 having instructions stored thereon. The instructions or computer programs may be configured to perform one or more of the operations or functions described with respect to the device 900. For example, the instructions may be configured to control or coordinate the operation of the various components of the device. Such components include, but are not limited to, display 902, one or more input/output components 963, one or more communication channels 964, one or more sensors 965, a speaker 906, microphone 907, and/or one or more haptic feedback devices 966. In some embodiments the speaker and microphone may be combined into a single unit and/or may share a common port through a housing of the device.

The processing units 961 of FIG. 9 may be implemented as any electronic device capable of processing, receiving, or transmitting data or instructions. For example, the processing units 961 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

In some embodiments the electronic device may accept a variety of bands, straps, or other retention mechanisms (collectively, “bands”). These bands may be removably connected to the electronic device by a lug that is accepted in a recess or other aperture within the device and locks thereto. The lug may be part of the band or may be separable (and/or separate) from the band. Generally, the lug may lock into the electronic device's recess and thereby maintain connection between the band and device. The user may release a locking mechanism to permit the lug to slide or otherwise move out of the recess. In some embodiments, the recess may be formed in the band and the lug may be affixed or incorporated into the device.

A user may change combinations of bands and electronic devices, thereby permitting mixing and matching of the two categories. It should be appreciated that devices having other forms and/or functions may include similar recesses and may releasably mate with a lug and/or band incorporating a lug. In this fashion, an ecosystem of bands and devices may be envisioned, each of which is compatible with another. A single band may be used to connect to devices, as one further example; in such embodiments the band may include electrical interconnections that permit the two devices to transmit signals to one another and thereby interact with one another.

In many embodiments, the electronic device may keep and display time, essentially functioning as a wristwatch among other things. Time may be displayed in an analog or digital format, depending on the device, its settings, and (in some cases) a user's preferences. Typically, time is displayed on a digital display stack forming part of the exterior of the device.

The display stack may include a cover element, such as a cover glass, overlying a display. The cover glass need not necessarily be formed from glass, although that is an option; it may be formed from sapphire, zirconia, alumina, chemically strengthened glass, hardened plastic and so on. Likewise, the display may be a liquid crystal display, an organic light-emitting diode display, or any other suitable display technology. Among other elements, the display stack may include a backlight in some embodiments.

The device also may comprise one or more touch sensors to determine a location of a touch on the cover glass. A touch sensor may be incorporated into or on the display stack in order to determine a location of a touch. The touch sensor may be self-capacitive in certain embodiments, mutual-capacitive in others, or a combination thereof.

Similarly, the device may include a force sensor to determine an amount of force applied to the cover glass. The force sensor may be a capacitive sensor in some embodiments and a strain sensor in other embodiments. In either embodiment, the force sensor is generally transparent and made form transparent materials, or is located beneath or away from the display in order not to interfere with the view of the display. The force sensor may, for example, take the form of two capacitive plates separated by silicone or another deformable material. As the capacitive plates move closer together under an external force, the change in capacitance may be measured and a value of the external force correlated from the capacitance change. Further, by comparing relative capacitance changes from multiple points on the force sensor, or from multiple force sensors, a location or locations at which force is exerted may be determined. In one embodiment the force sensor may take the form of a gasket extending beneath the periphery of the display. The gasket may be segmented or unitary, depending on the embodiment.

The electronic device may also provide alerts to a user. An alert may be generated in response to: a change in status of the device (one example of which is power running low); receipt of information by the device (such as receiving a message); communications between the device and another mechanism/device (such as a second type of device informing the device that a message is waiting or communication is in progress); an operational state of an application (such as, as part of a game, or when a calendar appointment is imminent) or the operating system (such as when the device powers on or shuts down); and so on. The number and types of triggers for an alert are various and far-ranging.

The alert may be auditory, visual, haptic, or a combination thereof. A haptic actuator may be housed within the device and may move linearly to generate haptic output (although in alternative embodiments the haptic actuator may be rotary or any other type). A speaker may provide auditory components of an alert and the aforementioned display may provide visual alert components. In some embodiments a dedicated light, display, or other visual output component may be used as part of an alert.

The auditory, haptic and/or visual components of the alert may be synchronized to provide an overall experience to a user. One or more components may be delayed relative to other components to create a desired synchronization between them. The components may be synchronized so that they are perceived substantially simultaneously; as one example, a haptic output may be initiated slightly before an auditory output since the haptic output may take longer to be perceived than the audio. As another example, a haptic output (or portion thereof) may be initiated substantially before the auditory output but at a weak or even subliminal level, thereby priming the wearer to receive the auditory output.

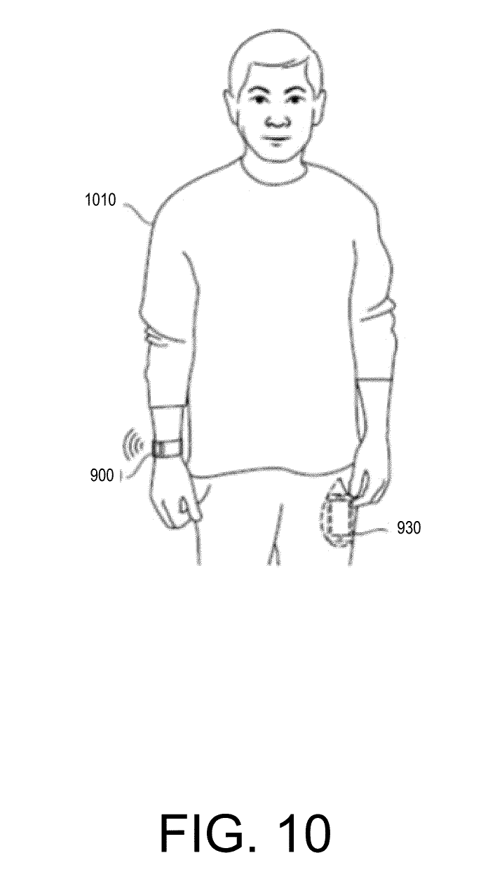

The example electronic device may communicate with other electronic devices either through a wired connection or wirelessly. Data may be passed between devices, permitting one device to relay information to another; control another; employ another's sensors, outputs, and/or inputs; and so on. FIG. 10 depicts a user 1010 wearing a sample electronic device 900 with a second electronic device 930 in his pocket. Data may be wirelessly transmitted between the electronic devices 900, 930, thereby permitting the user 1010 to receive, view, and interact with data from the second device 930 by means of the first electronic device 900. Thus, the user 1010 may have access to part or all of the second device's functionality through the first electronic device 900 without actually needing to interact directly with the second device 930.

Further, the electronic devices 900, 930 may cooperate not only to share data but to share functionality as well. For example, one of the two devices may incorporate a sensor, application, or function that the other lacks. The electronic device lacking such capabilities may request them from the other device, which may share wirelessly with the requesting device. Thus, multiple devices may operate together to provide expanded functions, software, access and the like between the two and ultimately to a user. As one non-limiting example, the electronic device 900 may be unable to place or receive telephone calls while the second device 930 may be able to do so. A user may nonetheless make and/or receive calls through the first device 900, which may employ the second device 930 to actually place or accept a call.

As another non-limiting example, an electronic device 900 may wirelessly communicate with a sales terminal nearby, thus permitting a user to quickly and efficiently conduct a transaction such as selling, buying, or returning a good. The electronic device may use near field communications technology to perform these and other functions.

As mentioned above, a band may be connected to two electronic devices and may serve as a wired communication path between the two. As another example, the devices may communicate wirelessly, thereby permitting one device to relay information from a second to a user. This latter example may be particularly useful when the second is inaccessible.

Certain embodiments may incorporate one or more biometric sensors to measure certain physiological characteristics of a user. The device may include a photoplesymogram sensor to determine a user's heart rate or blood oxygenation levels, for example. The device may also or instead include electrodes to measure the body impedance of a user, which may permit the device to estimate body fat percentages, the body's electrical activity, body impedance, and so on. Also include blood pressure, ultraviolet exposure, etc. Depending on the sensors incorporated into or associated with the electronic device, a variety of user characteristics may be measured and/or estimated, thereby permitting different health information to be provided to a user. In some examples, the sensed biometric information may be used by the alert manager, in part, for managing the electronic content and/or the incoming alerts.

Certain embodiments may be wirelessly charged. For example, an inductive charging base may transmit power to an inductive receiver within the device in order to charge a battery of the device. Further, by varying the inductive field between the device and base, data may be communicated between the two. As one simple non-limiting example, this may be used to wake the base from a low-power sleep state to an active charging state when the device is placed on the base. Other wireless charging systems also may be used (e.g., near field magnetic resonance and radio frequency). Alternatively, the device also may employ wired charging through electrodes.

In certain embodiments, the device may include a rotary input, which may take the form of a crown with a stem. The crown and stem may be rotated to provide the rotary input. Rotation of the stem and/or crown may be sensed optically, electrically, magnetically, or mechanically. Further, in some embodiments the crown and stem may also move laterally, thereby providing a second type of input to the device.

The electronic device may likewise include one or more buttons. The button(s) may be depressed to provide yet another input to the device. In various embodiments, the button may be a dome switch, rocker switch, electrical contact, magnetic switch, and so on. In some embodiments the button may be waterproof or otherwise sealed against the environment.

Various embodiments may include or otherwise incorporate one or more motion sensors. A motion sensor may detect motion of the device and provide, modify, cease, or otherwise affect a state, output, or input of the device or associated applications based on the motion. As non-limiting examples, a motion may be used to silence the device or acknowledge an alert generated by the device. Sample motion sensors include accelerometers, gyroscopic sensors, magnetometers, GPS sensors, distance sensors, and so on. Some embodiments may use a GPS sensor to facilitate or enable location and/or navigation assistance.

As shown in FIG. 9, the device 900 may also include one or more acoustic elements, including a speaker 906 and/or a microphone 907. The speaker 906 may include drive electronics or circuitry and may be configured to produce an audible sound or acoustic signal in response to a command or input. Similarly, the microphone 907 may also include drive electronics or circuitry and is configured to receive an audible sound or acoustic signal in response to a command or input. The speaker 906 and the microphone 907 may be acoustically coupled to port or opening in the case that allows acoustic energy to pass, but may prevent the ingress of liquid and other debris.

Certain embodiments may incorporate an ambient light sensor. The ambient light sensor may permit the device to sense a brightness of its environment and adjust certain operational parameters accordingly. For example, the electronic device may modify a brightness of a display in response to the sensed ambient light. As another example, the electronic device may turn the display off if little or no light is sensed for a period of time.

These and other functions, operations, and abilities of the electronic device will be apparent upon reading the specification in its entirety.

In certain embodiments, an electronic device may include one or more haptic modules for providing haptic feedback to the user. The embodiments described herein may relate to or take the form of one or more haptic actuators suitable to provide perceivable haptic feedback. Such actuators may include an electromagnetic coil, a permanent magnet or other magnetic field source. The magnetic field may induce motion in a mass of the haptic actuator by exerting a Lorentz force on the mass when the coil is energized. A direction of current through the coil determines the direction of motion of the mass, while the strength of the magnetic field determines the velocity of the mass and thus the magnitude of the haptic output.

In general, haptic actuators implemented in some embodiments may be configured to maximize or enhance resultant mechanical energy, given a very compact form factor of the electronic device.

In one embodiment, the haptic actuator may have a mass at least partially disposed within the coil when the mass is in a rest state. This mass may include two magnets of opposing polarities implemented as a magnet array affixed within a frame; the frame may provide extra weight to the mass and thus a stronger haptic output may be generated. A shaft may extend through the mass such that the mass may freely slide on the shaft. This motion may induce a motion in the housing of the actuator, which in turn may induce a motion in the housing of the electronic device.

The magnet array may generate a radial magnetic field that interacts with the magnetic field of the coil when the coil is energized by a current. The Lorentz force resulting from the interaction of the magnetic fields causes the mass to move along a shaft in a first direction. Reversing current flow through the coil reverses the Lorentz force. As a result, the magnetic field or force on the central magnet array is also reversed and the mass may move in a second direction. Thus, mass may move in both directions along the shaft, depending on the direction of current flow through the coil. Passing an alternating current through the coil may cause the central magnet array to move back and forth along a shaft.

In order to prevent the central magnet array from being attracted to the shaft, which could increase friction between the two and thereby increase the force necessary to move the central magnet array and frame, the shaft may be formed from a non-ferritic material such as tungsten, titanium, stainless steel, or the like, and the mass may slide along the shaft on bearings.

The actuator also may have structures that provide restoring force to the mass. For example, a spring may be located at either end of the shaft. As the mass impacts the spring, the spring compresses and stores kinetic energy. This kinetic energy may be released to return the mass along the shaft, thereby sending it to or near its initial starting position. The kinetic energy in the spring(s) may cooperate with the coil to move the magnet in such a fashion.

Although a linear actuator has been described herein, it should be appreciated that other types of actuators may be used in different embodiments. For example, some embodiments may employ a rotary actuator, a piezoelectric actuator, or any other suitable linear or non-linear actuator. Likewise, certain embodiments may employ multiple actuators working in concert.

In certain embodiments, an electronic device (e.g., device 108 or 204) may include one or more acoustic modules for transmitting and receiving acoustic energy. The acoustic module may be a speaker or microphone of an electronic device, as non-limiting examples.

The device housing may include a first acoustic port that is coupled to the acoustic module. In some instances, the acoustic module is configured to function as either a microphone or a speaker element for the device. However, for the purposes of the following description, the acoustic module is described as a speaker element or module. The acoustic port includes first and second orifices that facilitate the transmission of audible signals from the acoustic module to the user's ear. In this example, the orifices extend through the housing and acoustically connect internal components of the acoustic module with the external environment. In other examples, a single acoustic port may include more than two orifices or a single orifice. In some embodiments, the acoustic port may also include a housing structure (“umbrella”), screen mesh or other protective element configured to inhibit ingress of liquid or other foreign matter.

The umbrella structure generally prevents water or fluid from directly impacting the acoustic module. In one example, the acoustic port includes one or more orifices or openings that are offset with respect to an acoustic chamber of the module (e.g., the space between umbrella and mesh and including the one or more orifices. The umbrella structure may be formed into the outer surface of the case or housing. For example, the umbrella structure may be formed from the material located between two or more orifices or openings that are offset with respect to the acoustic chamber.

Further, certain embodiments may shape the acoustic chamber to reduce the likelihood that water accumulates in the chamber or other portion of the orifice. A screen may separate the acoustic cavity from the external environment and may impede the ingress of liquids or other foreign material from the external environment into the acoustic cavity. For example, the sidewalls of the orifice(s) may extend substantially to the surface of the screen in order to reduce surface tension of water in the orifice or chamber. Likewise, an exterior of the orifice may be chamfered to reduce surface tension of a liquid adjacent the orifice and thus facilitate liquid removal.

In the present example, the acoustic module is a speaker module. A speaker acoustic module may include various components for producing and transmitting sound, including a diaphragm, a voice coil, a center magnet, and side magnets/coils. In a typical implementation, the diaphragm is configured to produce sound waves or an acoustic signal in response to a stimulus signal in the voice coil. That is, a modulated stimulus signal in the voice coil causes movement of the diaphragm. Movement of the diaphragm creates sound waves, which propagate through the acoustic cavity of acoustic module and eventually out the port to the exterior environment. In some cases, the acoustic cavity functions as an acoustical resonator having a shape and size that is configured to amplify and/or dampen sound waves produced by movement of the diaphragm.

In certain embodiments, the acoustic module also includes structural support elements, such as an end wall and base. These elements may provide physical support for the speaker elements; various yokes, connectors and the like may also provide such support. Certain other embodiments may include a gasket to seal the interior of the device against the environment. It should be appreciated that the structure recited herein is meant as an example and not a limitation. For example, in alternative embodiments, the acoustic cavity may be formed from additional components or may be formed from a single component.

The acoustic module described above is provided as one example of a type of speaker acoustic module; other embodiments may use different types of speakers, microphones and the like. Further, although described in the context of a speaker, the foregoing is equally applicable to a microphone and many embodiments may likewise incorporate a microphone.

Illustrative methods and systems for managing user device connections are described above. Some or all of these systems and methods may, but need not, be implemented at least partially by architectures such as those shown at least in FIGS. 1-10 above. While many of the embodiments are described above with reference to alerts and/or notifications, it should be understood that any type of electronic content may be managed using these techniques. For example, a first telephone call may be being presented, when a different incoming telephone call is received. Based at least in part on the techniques described herein, a user device may be able to determine whether to answer the incoming call and hold the first call, ignore the incoming call, overlay the incoming call, displace the initial call, or the like based at least in part on categories of the call (e.g., time of day, area code, calling party, etc.) or the like. Further, in the foregoing description, various non-limiting examples were described. For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as but not limited to volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
receiving, by a wearable computing device of a user, a first alert for presentation by a display device of the wearable computing device, the first alert corresponding to a first alert category of a plurality of alert categories;
presenting the first alert via the display device;
storing a matrix of alert rules, the alert rules for managing presentation of additional alerts corresponding to the plurality of alert categories;
receiving a second alert configured to be presented by the display device, the second alert corresponding to a second alert category of the plurality of alert categories;
determining a presentation procedure for the received second alert during presentation of the first alert, the determined presentation procedure based at least in part on a particular alert rule of the alert rules that corresponds to the first alert category and the second alert category; and
presenting the second alert via the display device of the wearable computing device based at least in part on the determined presentation procedure.

2. The computer-implemented method of claim 1, wherein the matrix of alert rules comprises a row and a column for each of the plurality of alert categories.

3. The computer-implemented method of claim 2, wherein each cell of the matrix indicates a respective alert rule corresponding to a respective pair of individual alert categories of the plurality of alert categories.

4. The computer-implemented method of claim 3, wherein each cell of the matrix includes metadata identifying additional instructions for the respective alert rule, the additional instructions configured to alter the presentation procedure.

5. The computer-implemented method of claim 1, wherein the determined presentation procedure comprises at least one of overlaying the second alert with respect to the first alert, queuing the second alert, discarding the second alert, or displacing the first alert with the second alert.

6. The computer-implemented method of claim 1, wherein at least one of the first alert or the second alert are received from a second computing device of the user.

7. A system, comprising:
a memory configured to store computer-executable instructions; and
a processor in communication with the memory and the display device, the processor configured to execute the computer-executable instructions to at least:
configure a user interface to present electronic content, the electronic content corresponding to a first alert category of a plurality of alert categories;
receive a data structure comprising a plurality of rules, at least one rule of the plurality of rules corresponding to an entry of the data structure for an alert category pairing of the plurality of alert categories;
receive information that identifies an incoming alert;
determine a presentation method for the incoming alert based at least in part a corresponding rule of the plurality of rules; and
present the incoming alert based at least in part on determined presentation method.

8. The system of claim 7, wherein the entry for the alert category pairing comprises a position in the data structure where a row and a column meet, and wherein the alert category pairing comprises a pair of respective alert categories of the plurality of alert categories.

9. The system of claim 8, wherein the at least one rule is configured to instruct the processor regarding presentation of the incoming alert during presentation of the electronic content.

10. The system of claim 7, wherein the system is configured as a wearable device, wherein the electronic content is configured for presentation to a user of the wearable device, and wherein the electronic content is received from another computing device of the user.

11. The system of claim 7, wherein the electronic content or the incoming alert comprise at least one of an audio alert, a visual alert, or a haptic alert.

12. The system of claim 7, wherein at least one of the electronic content or the incoming alert are received from a server external to the system.

13. The system of claim 7, wherein the data structure is received from a developer computer, and wherein the data structure is configured to enable a developer associated with the developer computer to generate at least a subset of the plurality of rules.

14. The system of claim 7, wherein the incoming alert corresponds to a second alert category of the plurality of alert categories.

15. The system of claim 14, wherein the presentation method is further determined based at least in part on the second alert category.

16. A computer-readable storage medium storing computer-executable instructions that, when executed by a processor, configure the processor to perform operations comprising:
providing a first alert to a user device for presentation by the user device, the first alert associated with a first alert category;
receiving a data structure configured to store an alert rule for an alert category pair comprising the first alert category and a second alert category;
identifying a second alert configured to be presented by the user device, the second alert associated with the second alert category;
determining a presentation instruction based at least in part on the alert rule for the alert category pair; and
providing the second alert and the presentation instruction to the user device.

17. The computer-readable medium of claim 16, wherein the presentation instruction comprises information for presenting, by the user device, the second alert at a time when the first alert is being presented by the user device.

18. The computer-readable medium of claim 16, wherein the second alert and the presentation instruction are provided to the user device during presentation of the first alert.

19. The computer-readable medium of claim 16, wherein the operations further comprise providing the data structure to a third-party computing device for including the alert rule and other alert rules for other alert category pairs.

20. The computer-readable medium of claim 19, wherein the data structure is received from the third-party computing device.
